(19) United States
(12) Patent Application Publication
(10) Pub. No.: US 2024/0286708 A1
(43) Pub. Date: Aug. 29, 2024

(54) Optimized Metal Drive Roller

(71) Applicant: COMPAGNIE GENERALE DES ETABLISSEMENTS MICHELIN, Clermont-Ferrand (FR)

(72) Inventors: Yves POTIN, Clermont-Ferrand Cedex 9 (FR); Matthieu PELISSE, Clermont-Ferrand Cedex 9 (FR); Guillaume HENNEBERT, Clermont-Ferrand Cedex 9 (FR)

(21) Appl. No.: 18/572,707

(22) PCT Filed: Jun. 13, 2022
(86) PCT No.: PCT/FR2022/051115

§ 371 Date: Dec. 20, 2023

(30) Foreign Application Priority Data
Jun. 21, 2021 (FR) FR2106556

(51) Int. Cl. B62M 6/75

(52) U.S. Cl. CPC B62M 6/75

(57) ABSTRACT

Metal drive roller (1) for a light vehicle provided with a bicycle wheel, such as a bicycle or a wheelchair, having a frustoconical usable outer load-bearing surface (31, 32), the usable outer load-bearing surface (31, 32) having a plurality of indenting elements (4) having a radial height (hr) of between 0.5 mm and 5 mm, a mean circumferential length lc, a maximum axial width lam, and ending with a sharp point, the indenting elements (4) covering at least 80% of the usable outer load-bearing surface (31, 32). The projections of the sharp points of the indenting elements (4) perpendicular to the axis of rotation (2) onto the axis of rotation (2) are substantially equally distributed.

The present invention relates to a metal drive roller intended more specifically, but not exclusively, to be fitted to any light means of transport primarily using bicycle tires that is electrically assisted or has an electric motor, such as a bicycle, a tricycle or an electric wheelchair. It can be used to drive a multitude of rotary systems as required. The present invention also includes the system designed to use said roller.

There is a multitude of wheel drive systems for electrically assisted bicycles or wheelchairs. The wheel can be driven by contact between a roller with a tread surface made partly of rubber and a metal portion of the wheel, but this system loses much of its efficiency in wet weather, since wet metal is particularly slippery. The wheel cannot be driven by contact between this type of roller and the sidewall of the tire since the contact temperature quickly becomes too high, and the tire or roller quickly deteriorates. Furthermore, the grip between two rubber surfaces is poor in wet conditions.

Many systems use rollers in contact with the tread, but this contributes significantly to reducing the service life of the tire, particularly since the tread of the tire is designed to offer good grip in all weather conditions on tarmac roads or paths using tread patterns, but not to transfer torque via a more or less aggressive roller. Knurled metal drive rollers are particularly beneficial on account of their longevity, but cause particularly rapid wear by grooving.

Another beneficial system involves positioning a notched rubber on the sidewall of the tire and driving said notched rubber via a notched roller, the notches meshing with one another, causing little friction and therefore wear or heating (FR2998858). This system provides very good torque transmission even in wet weather and protects the tread from excessively quick wear. However, it requires the roller and the tire to be precisely positioned, which requires the intervention of professionals who are not always readily available.

The invention is intended to improve the device by improving each part thereof. Optimization of the metal drive roller improves torque transmission even in wet conditions, without having to position the roller very precisely in relation to the tire or a rotary element with a rubber strip in contact with said roller, and without reducing the service life of the parts of the device, either the drive roller or the rubber contact strip.

According to the invention, this objective is achieved by a metal drive roller comprising:
An axis of rotation,
A frustoconical outer load-bearing surface comprising one or more usable outer load-bearing surfaces arranged between two circumferential planes,
the one or more usable outer load-bearing surfaces comprising a plurality of indenting elements
the indenting elements having a radial height hr of between 0.5 mm and 5 mm, a mean circumferential length lc, a maximum axial width lam, and ending with a sharp point, the indenting elements covering at least 80% of each usable outer load-bearing surface,
for each usable outer load-bearing surface, the orthogonal projections of the sharp points of the indenting elements onto the axis of rotation of the roller being substantially equally distributed on the axis of rotation of the roller.

Since a drive roller has a geometry exhibiting symmetry of revolution about an axis of rotation, the geometry of the roller is described in a meridian plane, i.e. a plane containing the axis of rotation of the roller. For a given meridian plane, the radial, axial and circumferential directions denote the directions perpendicular to the axis of rotation of the roller, parallel to the axis of rotation of the roller and perpendicular to the meridian plane, respectively.

The roller according to the invention is frustoconical or cylindrical, a cylindrical roller being merely a truncated cone of which the generatrix is parallel to the axis of rotation of the roller. The benefit of a frustoconical roller is the ability to adjust the contact with the driven object in two directions. A first adjustment can be made by bringing the axis of the roller towards the contact surface of the driven object, and a finer adjustment can be made by moving the roller along its axis to increase the contact pressure by moving towards a larger mean diameter of the contact zone, or inversely to decrease the contact pressure. This makes it very easy to resolve difficulties positioning the roller in relation to the driven object.

To drive a tire via its sidewall, the roller must be frustoconical. This is because, in addition to facilitating adjustments, it should be borne in mind that, for one wheel revolution, the contact point of the roller on the radially outermost position on the tire travels further than the contact point of the roller on the radially innermost position on the tire. For a cylindrical roller, this would result in slipping over the entire contact surface except for the contact point at the midpoint of the contact surface with the tire. This slipping would cause wear, reducing the service life of the tire, which the invention is intended to prevent. To optimize wear, the angle of the generatrix of the truncated cone forms an angle (a) with the axis of rotation equal to the arcsine of the ratio between the smallest radial distance of the point of an indenting element of the drive roller and the distance to the axis of rotation of the tire from this contact point. In practice and preferably, the angle of the generatrix of the truncated cone forms an angle (a) with the axis of rotation of between 0° and 3°, preferably between 1° and 2°.

The indenting elements are patterns on the load-bearing surface in the form of cones or pyramids with square, rectangular or quadrangular bases on the load-bearing surface, of which the sharp points are the radially outermost portions of the drive roller. These indenting elements are designed so that the sharp points thereof come into contact with a contact strip positioned on the rotating driven object, with limited slipping. The radial heights thereof are between 0.5 mm and 5 mm, preferably less than 2 mm. There are several variants of the invention for a frustoconical roller: one in which the load-bearing surface is frustoconical and the indenting elements have the same radial height, and another in which the load-bearing surface is cylindrical and the indenting elements are of variable height so that the sharp points of the indenting elements are on a cone. The first form is beneficial as it makes the object more simple to define, but the invention includes both of these embodiments.

Preferably, the indenting elements are pyramidal with rectangular, quadrangular or square bases, which is easier to machine.

It is beneficial to have a multiplicity of contact points between the roller and the contact strip of the driven object. It is therefore beneficial for the indenting elements to cover at least 80% of the usable lead-bearing surfaces.

If the sharp points belong substantially to the same plane perpendicular to the axis of rotation, an irregular wear pattern will quickly appear on the contact strip of the driven object at the contact radius of the different points of the indenting elements. To prevent this type of wear of the contact strip, the points of the different indenting elements should not come into contact on the same radius, which can be achieved by distributing the sharp points of the indenting elements either randomly or geometrically in such a way that the projections of the sharp points perpendicular to the axis of rotation onto the axis of rotation are substantially equally distributed. Specifically, each portion of width lam of a usable load-bearing surface comprises a mean number n of indenting elements of which the sharp point is within the portion in question, the mean axial distance from each perpendicular projection onto the axis of rotation to the next is greater than 0.05 mm, between lam/4(n−1) and 2 lam(n−1). Preferably, on each usable outer load-bearing surface, the indenting elements are distributed along a helical path with a pitch equal to the maximum axial width lam of the indenting elements. This geometric distribution ensures that the projections of the sharp points perpendicular to the axis of rotation onto the axis of rotation are substantially equally distributed.

The distribution of the indenting elements along a helical path on a usable outer surface generates thereon an axial force that tends to unnecessarily shear the material of the contact strip of the driven object. To overcome this problem, an advantageous solution is for the drive roller to have two outer load-bearing surfaces, and for the indenting elements on each usable outer load-bearing surface to be distributed along a helical path with a pitch equal to the maximum axial width lam of the indenting elements, the angles of the respective helical paths, on each usable outer load-bearing surface, in relation to the axis of rotation of the roller having opposite signs from one usable outer load-bearing surface to the other.

In operation, each contact between a point of the drive roller and the contact strip of the driven object generates a noise. If the circular pitch of the points on the circumference is constant, the noise is concentrated at one frequency. This makes the noise considerably more annoying. An advantageous solution to this problem is to make the circumferential lengths lci of the indenting elements variable around the circumference within a range of values of more or less 25% than the mean circumferential length lc. A regular distribution of the circumferential lengths within this range enables a satisfactory distribution of the sound power.

Advantageously, the drive roller is corrosion-resistant. Where the roller is intended for outdoor use, it is essential that it not rust, since the rust would form an interface between the contact strip and the roller. Rust would diminish the ability of the system to transmit torque. Common stainless steels are usually soft steels that do not have sufficient wear resistance to provide the system with a sufficiently long service life. It is preferred that the indenting elements be made of stainless steel with a Vickers hardness of at least 560, such as maraging steel following thermal treatment, for example 4 hours at 480° C.

For use in electrically assisted bicycles or electrically assisted wheelchairs, the total axial height of the drive roller is between 10 mm and 30 mm. This is the radial height available on the height of the sidewall of a bicycle tire for bonding a contact strip that may come into contact with the drive roller.

Preferably, the outer load-bearing surface comprises an orifice at the base of each indenting element to drain the water from the outer load-bearing surface towards the axis of rotation of the roller. This water drainage is beneficial for outdoor use and for ensuring optimal grip between the drive roller and the contact strip, even in wet weather.

The invention comprises a drive roller as described above and a device comprising such a roller, in which said roller drives a rotating object by contact, the indenting elements of said roller being in rotary contact with a strip of deformable material having a stiffness of less than 100 MPa. The materials in rotary contact with the drive roller must be deformable so as not to blunt the indenting elements and to enable the transmission of drive forces. Preferably, the roller is in rotary contact with a strip of a rubber compound, rubber compounds being proven solutions known for their gripping capacity in wet and dry conditions, and for their resistance to wear. Preferably, the rubber compound forming the contact strip with the indenting element has a Shore A hardness of between 55 and 75, and the glass transition temperature where dynamic loss tgδ peaks is between −15° C. and 0° C. The expression “rubber compound” or rubber denotes a composition of rubber comprising at least an elastomer and a filler.

A conventional physical characteristic of an elastomeric compound is its glass transition temperature Tg, the temperature at which the elastomeric compound passes from a deformable rubbery state to a rigid glassy state. The glass transition temperature Tg of an elastomeric compound is generally determined during the measurement of the dynamic properties of the elastomeric compound, on a viscosity analyser for example of the Metravib VA4000 type, according to the standard ASTM D 5992-96. The dynamic properties are measured on a sample of vulcanized elastomeric compound, that is to say elastomeric compound that has been cured to a degree of conversion of at least 90%, the sample having the form of a cylindrical test specimen having a thickness equal to 2 mm and a cross-sectional area equal to 78.5 mm². The response of the sample of elastomeric compound to a simple alternating sinusoidal shear stress, having a peak-to-peak amplitude equal to 0.7 MPa and a frequency equal to 10 Hz, is recorded. A temperature scan is carried out at a constant rate of rise in temperature of +1.5° C./min. The results utilized are generally the complex dynamic shear modulus G*, comprising an elastic part G′ and a viscous part G″, and the dynamic loss tgδ, equal to the ratio G″/G′. A glass transition temperature Tg of the rubber compound is the temperature at which the dynamic loss tgδ peaks during the temperature sweep. Depending on the formulations and the mixture of several types of compounds, there may be one or several local peaks. For the invention, peak dynamic loss tgδ is the absolute maximum of the sweeping curve.

The mechanical behaviour of an elastomeric compound can be characterized, under static conditions, by its Shore A hardness, measured in accordance with the standards DIN 53505 or ASTM 2240, and, under dynamic conditions, by its complex dynamic shear modulus G*, as defined above, at a given temperature, typically at 23° C. Vickers hardness is measured according to standard ISO 6507/ASTM E 384.

For a Shore hardness of less than 55 or greater than 75, the drive roller is unable to transmit torque either because it does not sufficiently indent the surface of the contact strip or because it deforms said surface too readily without allowing shear stresses to occur. If peak dynamic loss tgδ lies outside the claimed range, the compound of the contact strip is destroyed, either by cracking or by reversion caused by excessively high temperature.

The device can be used to drive all manner of rotary objects having a contact strip, notably made of rubber, but is more specifically designed to drive the wheels of a light vehicle such as an electric wheelchair, bicycle, or tricycle in which the roller according to the invention drives at least one wheel of the vehicle by means of a rotary contact with a rubber-compound strip. The rubber-compound drive strip can be positioned anywhere on said wheel of the vehicle, notably on the inside of the rim, on one of the sidewalls of the rim, on one of the sidewalls of the tire, or on the tread of the tire. Depending on the position of the contact, the roller may be cylindrical, for example on the inside of the rim or on the tread of the tire.

If contact occurs on the sidewall of a rim or of a tire, the roller will be frustoconical. Thus, preferably, the device according to the invention is a light vehicle such as a bicycle, tricycle or wheelchair in which the metal drive roller according to the invention drives one wheel or the wheels by rotary contact with at least one tire, the contact occurring on the sidewall of said tire, and in which the angle of the generatrix of the truncated cone with the axis of rotation of the roller is between 0° and 3°, preferably between 1° and 2°. It is particularly beneficial for the contact to occur on the sidewall of the tire so as not to cause wear on the tread of the tire, and to maintain constant grip quality despite wearing of the tread, and to maximize the contact area between the drive roller and the contact strip. This is because, compared to other possible contact zones such as the sidewall of the rim or the inside of the rim, which are not deformable, the deformable sidewall of the tire makes it possible to maximize the number of indenting elements in contact, and therefore to maximize the perfect grip of both portions, which is very beneficial in terms of energy economy for an electric bicycle and in terms of driving precision for an electrically assisted wheelchair in particular.

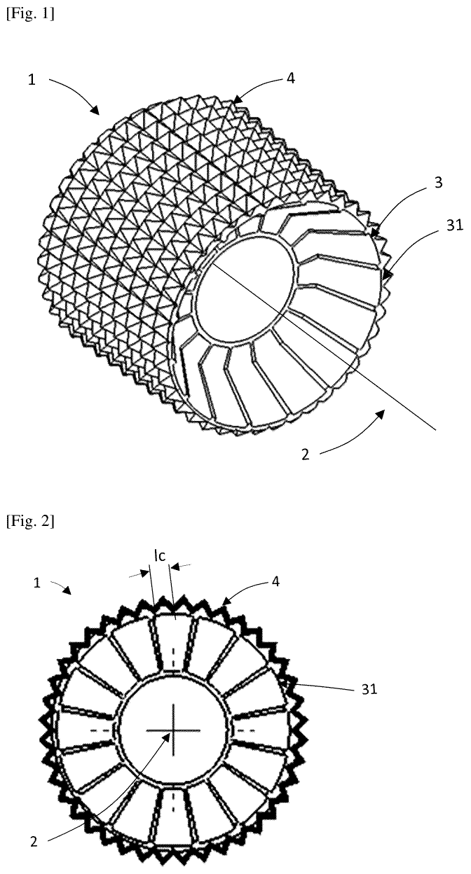

The features of the invention are illustrated schematically in FIGS. 1 to 6, and not shown to scale.

FIG. 1 is a cavalier projection of a metal drive roller 1 according to the invention with its axis of rotation 2. Said roller 1 has a frustoconical outer load-bearing surface 3 comprising a single usable load-bearing surface 31, which in this case is the same as the load-bearing surface 3. The whole of the usable load-bearing surface is covered with indenting elements 4.

FIG. 2 shows the roller 1 in cross section in a plane perpendicular to its axis of rotation 2. This figure shows the mean circumferential length lc, each of the indenting elements being of equal length in this case.

FIG. 3 is a side view, the figure containing the axis of rotation of the roller. This figure shows the angle a of the truncated cone, in this case 1.5°, the radial height hr of the indenting elements and the maximum axial width (lam), all of the indenting elements having the same axial width in this case.

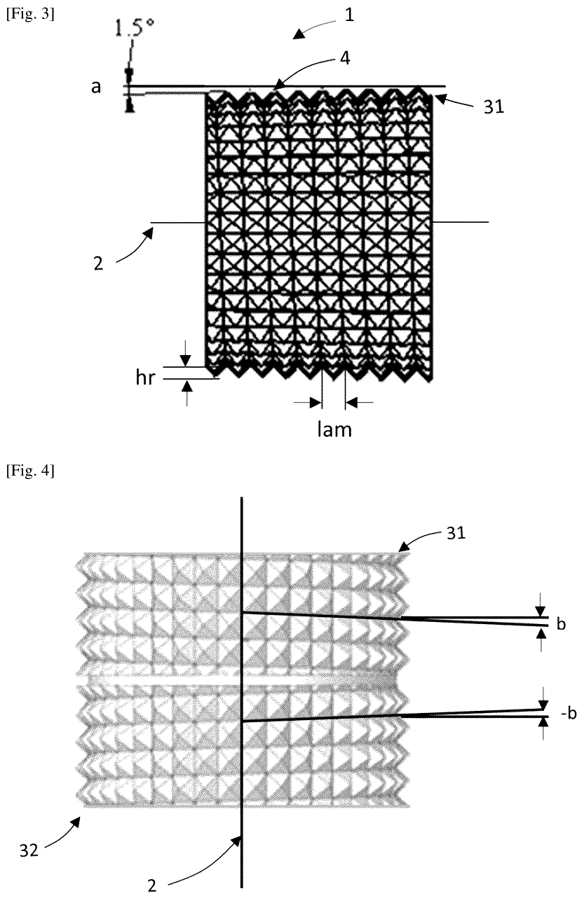

FIG. 4 shows a drive roller according to the invention having two usable outer load-bearing surfaces 31 and 32, in which, on each usable outer load-bearing surface 31, 32, the indenting elements 4 are distributed along a helical path with a pitch equal to the maximum axial width lam of the indenting elements 4, the angles of the helical paths b, −b in relation to the perpendicular to the axis of rotation 2 having opposite signs from one usable surface 31 to the other 32.

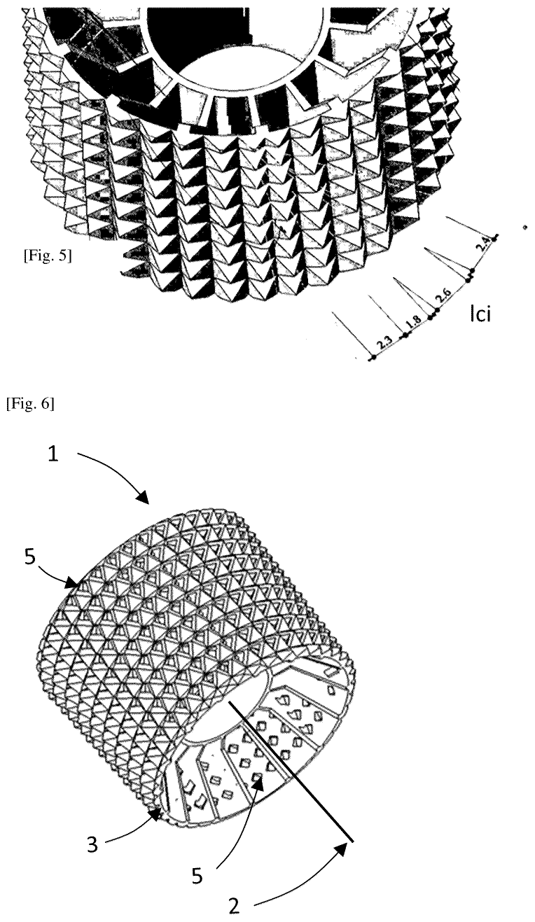

FIG. 5 shows a variant of the invention in which the circumferential lengths lci of the indenting elements 4 are variable around the circumference within a range of values of more or less 25% (between 1.8 mm and 2.6 mm) than the mean circumferential length lc, in this case 2.2 mm.

FIG. 6 shows a variant of the invention in which the outer load-bearing surface 3 comprises an orifice 5 at the base of each indenting element to drain the water from the outer load-bearing surface 3 towards the axis of rotation 2 of the roller 1.

Development of the invention required several testing phases, one on the shape of the metal drive roller and the other on the rubber compound used to transmit force without deteriorating over time. Several machine tests were carried out:
A grip test in wet conditions: a bicycle wheel equipped with a dynamometer is driven by a motor equipped with the drive roller being tested. A smooth strip of the rubber compound being tested is adhesively bonded to the sidewall of the tire. The test is carried out with a water spray. Solutions that do not enable a torque of 20 Nm to be exceeded are discarded.
A wear test of 5000 km is carried out on the same test bed but without water being sprayed. Solutions exhibiting wear are discarded.

A bladed metal roller in which contact with the rubber-compound strip is made by lines of length equal to the height of the roller was tested. This solution transmitted torque very efficiently, but the contact strip was damaged within 10 km.

Metal rollers in which the indenting elements are pyramidal indenting elements of variable height from 0.1 mm to 5 mm were tested. Rollers with a height of less than 0.5 mm did not enable transmission of a torque of at least 20 Nm. Heights above 5 mm are not of interest on account of machining costs.

Knurled metal rollers in which the indenting elements do not follow a helical path are no longer able to deliver the required torque after approximately 200 km on account of the grooving of the rubber-compound contact strip.

Twenty-five rubber compounds were tested for the rubber-compound contact strip adhesively bonded to the sidewall of the tire. Their Shore A hardness values were between 50 and 80, this parameter being linked to their stiffness, and their glass transition temperatures, this parameter being linked to grip, were between −90° C. and −10° C. The three satisfactory solutions for the two tests all have a Shore A hardness of between 55 and 75, and a glass transition temperature at which the dynamic loss tgδ peaks of between −15° C. and 0° C.

Experience has shown, for example, that the rubber compounds of bicycle tire treads, the glass transition temperatures of which are extremely low, usually between −50° C. and −60° C., do not allow the invention to work. This is because these compounds are designed to provide grip, at a high pressure between 8 and 15 bar, on asphalt or bare ground and are not designed to be driven by a metal roller equipped with indenting elements that stress the compound at a different frequency to the intended usage of said compounds. These compounds were quickly destroyed by the roller.

The solution with a roller as described in the invention combined with a rubber-compound contact strip having the aforementioned properties successfully completed the selection tests.

A validation test on an electrically assisted bicycle in urban usage over 1500 km validated the chosen solution in actual usage conditions. A rubber-compound contact strip was adhesively bonded to the sidewall. It had a Shore hardness of 63 and a glass transition temperature of −5° C.

The invention was also tested on a wheelchair provided with motors for electrical assistance and 24-inch (540 mm) bicycle wheels. Four solutions were tested with different drive rollers with an identical diameter of 23 mm and a height of 20 mm:
A solution A in which the wheel is driven by a roller with a rubber lining rubbing against the metal sidewall of the wheel,
A solution B in which the wheel is driven by a roller with a rubber lining identical to solution A rubbing against the sidewall of the tire provided with a smooth circumferential drive strip,
A solution C in which the wheel is driven by a roller with a toothed plastic lining meshing in the sidewall of the tire, the sidewall of the tire being provided with an ad-hoc complementary meshing system to transmit drive and braking forces,
A solution D in which the wheel is driven by a frustoconical roller having an angle of 1.8° as described by the invention, provided with pyramidal indenting elements 1.2 mm tall made of maraging steel, a mean circumferential length of 2 mm, a maximum axial width of 2 mm, the indenting elements covering 100% of the load-bearing surface, the indenting elements being arranged along a helical path with a pitch of 2 mm, the roller being in contact with the sidewall of the tire provided with a smooth circumferential drive strip with a Shore hardness of 63 and a glass transition temperature of −5° C.

The different solutions were tested in urban conditions over the same one-hour trip on pavements with height differences. They were also tested on outdoor tracks in wet conditions with a slalom handling test using cones.

Solutions A, B and D are significantly simpler to assemble than solution C, which requires the very precise placement of the roller and the wheel, which is not particularly compatible with use of the wheelchair in urban conditions. This is because wheelchairs used in towns are subjected to pavement impacts that could upset this placement. It also requires a meshing system to be positioned very precisely on the tire.

Solutions A and B provide good force transmission in dry conditions. Solution A is the simplest to install from a technical perspective, but is not very efficient in wet conditions, since the rubber rollers slipping on the steel of the rim prevented successful completion of the handling test without touching the cones. Solution B has the same problem as solution A, with the contact between two wet rubber surfaces not providing very good grip. In addition to this, the problem of the rubber of the roller heating up in dry conditions means that solution B is not very durable.

The invention offers a solution to the problem while maintaining excellent handling in wet conditions, equivalent to solution C, since the indenting elements break the film of water on the contact surface touching the tire. The flexibility of contact between the roller and the tire allows extremely simple positioning of one on the other. After one hour of urban usage, the rubber strip adhesively bonded to the sidewall of the tire exhibits no sign of wear.

The invention therefore successfully provides a solution that is simple to install, provides excellent handling in wet conditions and is beneficial in terms of wear and is therefore durable.

1. A metal drive roller comprising:
an axis of rotation,
a frustoconical outer load-bearing surface comprising one or more usable outer load-bearing surfaces arranged between two circumferential planes,
the one or more usable outer load-bearing surfaces comprising a plurality of indenting elements
the indenting elements having a radial height (hr) of between 0.5 mm and 5 mm, a mean circumferential length lc, a maximum axial width lam, and ending with a sharp point, the indenting elements covering at least 80% of each usable outer load-bearing surface,
wherein, for each usable outer load-bearing surface, the orthogonal projections of the sharp points of the indenting elements onto the axis of rotation of the roller are substantially equally distributed on the axis of rotation of the roller.

2. The metal drive roller according to claim 1, wherein, on each usable outer load-bearing surface, the indenting elements are distributed along a helical path with a pitch equal to the maximum axial width lam of the indenting elements.

3. The metal drive roller according to claim 1, comprising two usable outer load-bearing surfaces wherein, on each usable outer load-bearing surface, the indenting elements are distributed along a helical path with a pitch equal to the maximum axial width lam of the indenting elements, the angles of the respective helical paths (b, −b), on each usable outer load-bearing surface, in relation to the perpendicular to the axis of rotation of the roller having opposite signs from one usable outer load-bearing surface to the other.

4. The metal drive roller according to claim 1, wherein the circumferential lengths lci of the indenting elements are variable around the circumference within a range of values of more or less 25% than the mean circumferential length lc.

5. The metal drive roller according to claim 1, wherein the indenting elements are made of stainless steel with a Vickers hardness of at least 560.

6. The metal drive roller according to claim 1, wherein the outer load-bearing surface comprises an orifice at the base of each indenting element to drain the water from the outer load-bearing surface towards the axis of rotation of the roller.

7. A device comprising: a rotating object, a rubber-compound strip and a metal drive roller according to claim 1, wherein said roller drives a rotating object by contact, the indenting elements of said roller being in rotary contact with a rubber-compound strip.

8. The device according to claim 7, wherein the rubber compound forming the contact strip with the indenting element has a Shore A hardness of between 55 and 75, and a glass transition temperature of between −15° C. and 0° C.

9. A light vehicle such as a bicycle, tricycle or wheelchair comprising the device according to claim 7, in which the roller drives at least one wheel of the vehicle by rotary contact with a rubber-compound strip.

10. The light vehicle such as a bicycle, tricycle or wheelchair comprising the device according to claim 7, wherein the metal drive roller drives at least one wheel by rotary contact with at least one tire, the contact occurring on the sidewall of said tire, and wherein the angle (a) of the generatrix of the truncated cone with the axis of rotation of the roller is between 0° and 3°.

11. The light vehicle of claim 10, wherein the angle (a) of is between 1° and 2°.
